(19) United States
(12) Patent Application Publication
(10) Pub. No.: US 2009/0051159 A1
(43) Pub. Date: Feb. 26, 2009

(54) FLUID FITTING FOR AN AGRICULTURAL DRIP IRRIGATION SYSTEM

(76) Inventors: Scott Glenn Cameron, Escondido, CA (US); Jack Fairchild Butler, Carlsbad, CA (US); Jerry Lee McDonald, Oceanside, CA (US)

Correspondence Address: DEERE & COMPANY, ONE JOHN DEERE PLACE, MOLINE, IL, 61265, US

(21) Appl. No.: 11/841,186

(22) Filed: Aug. 20, 2007

(51) Int. Cl. F16L 55/00

(52) U.S. Cl. 285/5

(57) ABSTRACT

An agricultural irrigation assembly includes an irrigation hose, a drip tape, and a fluid fitting interconnecting the irrigation hose with the drip tape. The fluid fitting includes a tab fitting and a swivel fitting. The tab fitting has a tab and a threaded collar. The tab is insertable into an opening formed in the irrigation hose and held in place using the collar. The swivel fitting is fluidly coupled to the tab fitting. The swivel fitting includes a threaded fitting defining a longitudinal axis. The threaded fitting is rotatable about the longitudinal axis and substantially immovable in a direction parallel to the longitudinal axis.

### FIELD OF THE INVENTION

The present invention relates to agricultural irrigation systems, and, more particularly, to agricultural drip irrigation systems.

### BACKGROUND OF THE INVENTION

Agricultural irrigation systems have been used for centuries to apply water to agricultural crops. The first type of irrigation systems were flood irrigation systems in which trenches formed in the soil directed water via gravitational force to an agricultural site. For example, water can be diverted from a river by a gated trench to an agricultural site at a lower elevation. These type of irrigation systems are still in use today in certain areas where water sources and the topography allow, e.g., certain areas of the western U.S.A. and Australia.

Other more mechanized types of irrigation systems are also used. For example, center pivot irrigation systems of the high pressure or low pressure type receive water from an electric powered water pump. The water typically is pumped from a well, river or irrigation pond. Intermittently spaced towers carrying a supply pipe are driven by electric motors or water driven turbines.

Other types of irrigation systems such as “travelers” are also used. In a traveler system, a flexible hose is coupled with a standpipe in a field supplied by a water pump, and a cable is drawn across the field. The water passes through a water driven turbine prior to exiting from a pivoting gun, and the water turbine reels up the cable on a spool, causing the traveler to move across the field dragging the hose behind.

With a center pivot or traveler irrigation system as described above, an appreciable amount of the water is lost through evaporation as the water travels through the air, and through run-off after the water falls to the ground. To reduce evaporation, such irrigation systems may be operated at night. However, depending upon the amount of acreage to irrigate, it may be necessary to operate the irrigation system around the clock, 7 days a week.

Another more recent type of irrigation is drip irrigation, in which water flows at a low pressure (e.g., typically 5 to 15 psi) through a flattened tube and is discharged through openings in the tube in close proximity to the plants. The water exits at a low pressure from the flattened tube, and is thus also referred to as a “drip tape.” A supply header receives water from a water pump and a plurality of the drip tapes are coupled with the supply header in a network of drip tapes corresponding to the particular shape of the field.

A drip irrigation system as described above has the advantages of directly delivering water and nutrients to an area in close proximity to the plants which maximizes plant growth and production, while limiting problems associated with other types of irrigation systems, such as erosion, disease, weed growth, soil saturation, energy costs and water conservation.

One type of supply header used in a drip irrigation system is known as a lay flat hose. An example of such a lay flat hose is manufactured and marketed under the name “PRO-FLAT” brand hose by Roberts Irrigation Products, Inc., San Marcos, Calif., which in turn is a subsidiary of the assignee of the present invention. (see, e.g., the website www.robertsirrigation.com). Problems exist in connecting the lay flat hose together with the drip tape. On one hand, the connections must be easily made and fluid tight to ensure proper operation. On the other hand, the connections must also be easily disconnected and not so bulky as to interfere with storage of the lay flat hose and/or drip tape during the off season when the drip irrigation is not in use.

What is needed in the art is a fluid fitting for an agricultural drip irrigation system which quickly and easily connects and disconnects a hose with a drip tape, effectively fluidly seals between the hose and drip tape, and does not interfere with storage of the hose and drip tape in the off season.

### SUMMARY OF THE INVENTION

The invention comprises, in one form thereof, an agricultural irrigation assembly, including an irrigation hose, a drip tape, and a fluid fitting interconnecting the irrigation hose with the drip tape. The fluid fitting includes a tab fitting and a swivel fitting. The tab fitting has a tab and a threaded collar. The tab is insertable into an opening formed in the irrigation hose and held in place using the collar. The swivel fitting is fluidly coupled to the tab fitting. The swivel fitting includes a threaded fitting defining a longitudinal axis. The threaded fitting is rotatable about the longitudinal axis and substantially immovable in a direction parallel to the longitudinal axis.

The invention comprises, in another form thereof, a method of fluidly interconnecting an irrigation hose with a drip tape, including the steps of: forming an opening in the irrigation hose; inserting a tab of a fluid fitting into the hole; tightening a collar to hold the tab in place within the hole; and threading a threaded swivel fitting of the fluid fitting into a mating threaded fitting on an adapter, the adapter being coupled with the drip tape.

### BRIEF DESCRIPTION OF THE DRAWINGS

FIG. 1 is an exploded, perspective view of an embodiment of a fluid fitting of the present invention for fluidly interconnecting an irrigation hose with a drip tape; and

FIG. 2 is a side, sectional view through the fluid fitting of FIG. 1, taken along line 2-2 in FIG. 1.

### DETAILED DESCRIPTION OF THE INVENTION

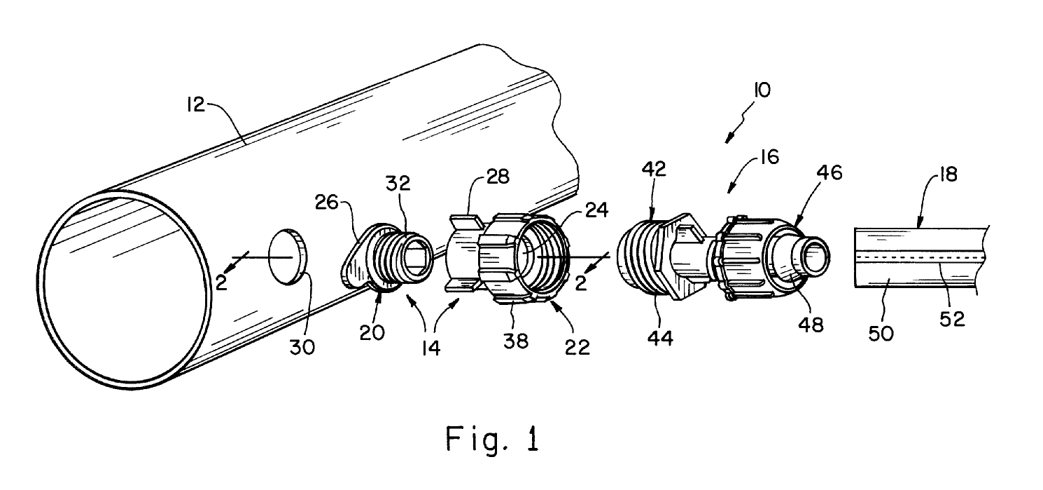

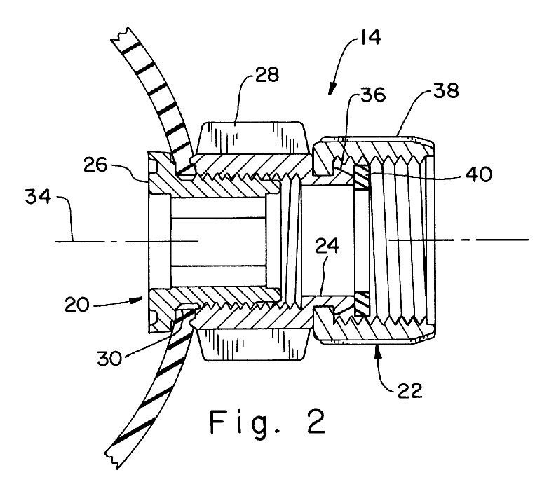

Referring now to the drawings, and more particularly to FIGS. 1 and 2, there is shown an embodiment of an agricultural irrigation assembly 10, including an irrigation hose 12, a fluid fitting 14, an adapter 16, and a drip tape 18. Irrigation hose 12 acts as a supply header to drip tape 18, such as when configured as a sub-main line. In the embodiment shown, irrigation hose 12 is configured as a lay flat hose and used as a sub-main line. Typically a plurality of drip tapes 18 are connected in a parallel manner to irrigation hose 12 and extend across a field or other area to be irrigated. However, only a single drip tape 18 is shown connected to irrigation hose 12 for simplicity sake.

Fluid fitting 14 includes a tab fitting 20 and a swivel fitting 22, fluidly interconnected by a fluid conduit 24. Tab fitting 20 includes a tab 26 with a depending threaded portion 32, and a threaded collar 28. Tab 26 is insertable into an opening 30 formed in irrigation hose 12 and held in place using collar 28. More particularly, tab 26 is generally tear drop shaped and is sized to just slide into opening 30, with depending male threaded portion 32 extending through opening 30 to the outside of hose 12. Collar 28 has female threads which are sized and configured to thread with male threaded portion 32, and irrigation hose 12 is clamped between tab 26 and threaded collar 28. The tear drop shape of tab 26 assists in insertion of tab 26 within opening 30 in hose 12.

In the embodiment shown, threaded collar 28 and male threaded portion 32 each have left hand threads which assist in self tightening of collar 28 during use. However, threaded collar 28 and male threaded portion 32 could also have right hand threads.

Swivel fitting 22 is fluidly coupled to tab fitting 20 by fluid conduit 24. Swivel fitting 22, fluid conduit 24 and tab fitting 20 all have a common longitudinal axis 34, but could be disposed at a different angle relative to each other. In the embodiment shown, fluid conduit 24 is formed integral with threaded collar 28 and has a flange 36 at an opposite end.

Swivel fitting 22 includes a threaded fitting 38 which is rotatable about longitudinal axis 34 and substantially immovable relative to fluid conduit 24 in a direction parallel to longitudinal axis 34. More particularly, threaded fitting 38 swivels around flange 36, thereby allowing hose 12 to remain in a stationary position when coupling with adapter 16. Threaded fitting 38 is preferably configured as a standard garden hose type fitting of the male or female type. In the embodiment shown, threaded fitting 38 is configured as a standard garden hose female fitting with a rubber gasket 40 positioned adjacent flange 36. Threaded fitting 38 could also be configured as a male threaded fitting which swivels about flange 36, depending upon the application.

Adapter 16 has a first end 42 with a threaded fitting 44 which is coupled with threaded fitting 38 of swivel fitting 22. In the embodiment shown, threaded fitting 44 is configured as a standard garden hose male fitting which mates with female threaded fitting 38 of fluid fitting 14.

Adapter 16 also has a second end 46 which is coupled with drip tape 18. Second end 46 may take various configurations to mate with different drip tapes. For example, in the embodiment shown, second end 46 has a barbed fitting 48 which slides into a drip tape and is clamped using suitable clamps, cable ties, etc.

Drip tape 18 may be of known construction, and generally includes a sidewall 50 with opposite longitudinal edges which are overlapped and affixed to each other to define an overlap channel 52 with a plurality of spaced emitters (shown but not numbered) through which water is discharged at low pressure. Although drip tape 18 has a flattened, tape-like construction, it is possible to use other types of irrigation conduits with the present invention which are also known to be used in drip irrigation systems, such as irrigation conduits having oval or circular cross sections. Drip tape 18 may be formed from a biodegradable plastic. Without limitation, examples of biodegradable plastics include polymeric and polyester materials of many specific types.

To couple irrigation hose 12 with drip tape 18, an opening 30 is formed in irrigation hose 12 (if not already present). Tab 26 is inserted into opening 30 such that male threaded portion 32 extends outside of hose 12. Collar 28 is tightened and hose 12 is clamped between collar 28 and tab 26. Female threaded swivel fitting 22 of fluid fitting 14 is threaded onto male threaded fitting 44 of adapter 16 and tightened until male threaded fitting 44 seals against gasket 40. Barbed fitting 48 of adapter 16 typically would have already been connected to drip tape 18. At the end of the irrigation season, female threaded fitting 38 can simply be disconnected from male threaded fitting 44 to disconnect drip tape 18 from hose 12. Fluid fitting 14 may remain in hose 12 in the off season, either in the field or at a remote storage location, and simply reconnected to an adapter 16 the following season to reconnect another drip tape 18.

Having described the preferred embodiment, it will become apparent that various modifications can be made without departing from the scope of the invention as defined in the accompanying claims.

1. A fluid fitting for an agricultural irrigation assembly, comprising:
a tab fitting including a tab and a threaded collar, said tab being insertable into an opening formed in an irrigation hose and held in place using said collar; and
a swivel fitting fluidly coupled to said tab fitting, said swivel fitting including a threaded fitting defining a longitudinal axis, said threaded fitting being rotatable about said longitudinal axis and substantially immovable in a direction parallel to said longitudinal axis.

2. The fluid fitting of claim 1, including a fluid conduit fluidly interconnecting said tab fitting with said swivel fitting.

3. The fluid fitting of claim 2, wherein said threaded fitting is substantially immovable relative to said fluid conduit in said direction parallel to said longitudinal axis.

4. The fluid fitting of claim 1, wherein said threaded fitting comprises one of a female threaded fitting and a male threaded fitting.

5. The fluid fitting of claim 4, wherein said threaded fitting is a standard garden hose type female fitting.

6. The fluid fitting of claim 1, wherein said tab fitting and said swivel fitting have a common longitudinal axis.

7. The fluid fitting of claim 1, wherein said tab is generally tear drop shaped.

8. The fluid fitting of claim 1, wherein said collar is left-hand threaded for self tightening during use.

9. The fluid fitting of claim 1, wherein said irrigation hose comprises a lay flat hose.

10. An agricultural irrigation assembly, comprising:
an irrigation hose;
a drip tape; and
a fluid fitting interconnecting said irrigation hose with said drip tape, said fluid fitting including:
a tab fitting having a tab and a threaded collar, said tab being insertable into an opening formed in said irrigation hose and held in place using said collar; and
a swivel fitting fluidly coupled to said tab fitting, said swivel fitting including a threaded fitting defining a longitudinal axis, said threaded fitting being rotatable about said longitudinal axis and substantially immovable in a direction parallel to said longitudinal axis.

11. The agricultural irrigation assembly of claim 10, including a fluid conduit fluidly interconnecting said tab fitting with said swivel fitting.

12. The agricultural irrigation assembly of claim 11, wherein said threaded fitting is substantially immovable relative to said fluid conduit in said direction parallel to said longitudinal axis.

13. The agricultural irrigation assembly of claim 10, wherein said threaded fitting comprises one of a female threaded fitting and a male threaded fitting.

14. The agricultural irrigation assembly of claim 13, wherein said threaded fitting is a standard garden hose type female fitting.

15. The agricultural irrigation assembly of claim 10, including an adapter coupled with said drip tape, said adapter having a first end with a threaded fitting coupled with said threaded fitting of said swivel fitting, and a second end coupled with said drip tape.

16. The agricultural irrigation assembly of claim 15, wherein said second end of said adapter is one of a barbed fitting, compression fitting and threaded fitting.

17. The agricultural irrigation assembly of claim 10, wherein said tab fitting and said swivel fitting have a common longitudinal axis.

18. The agricultural irrigation assembly of claim 10, wherein said tab is generally tear drop shaped.

19. The agricultural irrigation assembly of claim 10, wherein said collar is left-hand threaded for self tightening during use.

20. The agricultural irrigation assembly of claim 10, wherein said irrigation hose comprises a lay flat hose.

21. A method of fluidly interconnecting an irrigation hose with a drip tape, comprising the steps of:
forming an opening in the irrigation hose;
inserting a tab of a fluid fitting into the hole;
tightening a collar to hold the tab in place within the hole; and
threading a threaded swivel fitting of said fluid fitting into a mating threaded fitting on an adapter, said adapter being coupled with the drip tape.

22. The method of claim 21, wherein said threaded swivel fitting of said fluid fitting is a female threaded swivel fitting, and said mating threaded fitting on said adapter is a male threaded fitting.
